(19) United States
(12) Patent Application Publication
(10) Pub. No.: US 2010/0164924 A1
(43) Pub. Date: Jul. 1, 2010

(54) Bias control circuit, source driver, and liquid crystal display device

(75) Inventors: Ki-Won Seo, Seoul (KR); Do-Yoon Kim, Hwaseong-si (KR); Jae-Wook Kwon, Yongin-si (KR); Sung-Pil Choi, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/654,256

(22) Filed: Dec. 15, 2009

(30) Foreign Application Priority Data
Dec. 29, 2008 (KR) 10-2008-0135241

(51) Int. Cl. G09G 5/00; G09G 3/36

(52) U.S. Cl. 345/208; 345/98

(57) ABSTRACT

A bias control circuit includes a counter unit, a decoder, a level shifter, and a bias block. The bias control circuit provides plurality bits of first signal indicating information on a plurality of groups based on a number of scanning lines and a number of groups. The decoder decodes the first signal to provide plurality bits of second signal. The level shifter shifts a voltage level of the second signal to provide a bias resistor selection signal. The bias block provides respective bias voltages to the corresponding respective groups by respective resistances being selected in response to the bias resistor selection signal.

### CROSS-REFERENCE TO RELATED APPLICATIONS

This application claims priority under 35 USC §119 to Korean Patent Application No. 2008-0135241, filed on Dec. 29, 2008 in the Korean Intellectual Property Office (KIPO), the contents of which are herein incorporated by reference in their entirety.

### BACKGROUND

1. Field

Example embodiments relate to display devices, and particularly to a liquid crystal display device, a source driver and a bias control circuit.

2. Related Art

A liquid crystal display (LCD) device is used in note-book computers, televisions and mobile phones, because the LCD device is light, thin, small and consumes less power.

Generally, the LCD device may include a LCD panel for displaying images, and a source driver and a gate driver for driving the LCD panel. The LCD panel may include a plurality of data lines for receiving data voltages from the source driver and a plurality of gate lines for receiving gate voltages from the gate driver. A plurality of pixel areas are defined by the data lines and the gate lines in the LCD panel, and each pixel area includes a pixel having a thin film transistor and a pixel electrode.

The source driver is connected to a corresponding data line, and the source driver includes a plurality of output buffers for buffering data voltages and providing the buffered data voltages to the data lines. Because the data voltages for driving the pixels are output through the output buffers, characteristics of the output buffers play a role in the quality of images displayed on the LCD device.

In addition, as the size of the LCD panel becomes larger, the source driver has to drive more panel loads, and total current consumption of the LCD device increases. When the current consumption increases, temperature of the LCD panel increases, thereby degrading heat radiation characteristics, and transient transition peak current increases, thereby increasing electromagnetic interference (EMI).

### SUMMARY

According to an example embodiment, a bias control circuit may include a counter unit configured to provide plurality bits of a first signal indicating information on a plurality of scanning lines divided into a equal number of a plurality of groups, the plurality of scanning lines constituting one frame; a decoder configured to decode the first signal to provide a plurality of bits of a second signal; a level shifter configured to shift a voltage level of the second signal to provide a bias resistor selection signal, the bias resistor selection signal being enabled based on bit value of the second signal; and a bias block configured to select a resistance based on a value of the bias resistor selection signal and configured to provide a bias voltage corresponding to the resistance selected.

According to an example embodiment, the counter unit may include a first counter that counts a pulse of a horizontal synchronization signal that synchronizes the scanning lines in each group; a logic circuit that provides a group counting signal which is enabled when the first counter completes counting the scanning lines in each group; and a second counter that counts the group counting signal to provide the first signal.

According to an example embodiment, the first counter may be reset when the first counter completes counting the scanning lines in each group, and the first counter and the second counter may be reset in response to a vertical synchronization signal that synchronizes the one frame.

According to an example embodiment, the logic circuit may include a first AND gate that may receive upper half bits of an output of the first counter; a second AND gate that may receive lower half bits of the output of the first counter; and a third AND gate that may perform a logic operation on the outputs of the first and second AND gates to provide the group counting signal.

According to another example embodiment, the logic circuit may include a first AND gate that receives upper half bits of an output of the first counter; a second AND gate that receives lower half bits of the output of the first counter; a third AND gate that performs a logic operation on the outputs of the first and second AND gates; and an OR gate that performs a logic operation on the outputs of the third AND gate and the bias resistor selection signal to provide the group counting signal.

According to an example embodiment, the bias resistor selection signal may be enabled during the counting of the plurality of scanning lines.

According to an example embodiment, the bias block may include a plurality of switches that receive the bias resistor selection signal; and a plurality of resistors, each resistor of the plurality of resistors being connected to each switch of the plurality of switches, wherein each resistor is connected in response to the bias resistor selection signal to provide a corresponding bias voltage.

According to another example embodiment the bias control circuit may further include a reset circuit that may generate a reset signal which simultaneously resets the first counter and the second counter in response to a main clock signal and a vertical synchronization signal.

According to an example embodiment a source driver may include the bias control circuit according to example embodiments disclosed above; an input unit which may receive digital data signal and sequentially stores the digital data signal; a digital to analog converter configured to convert the stored digital data signal to an analog data; and an output buffer unit configured to output the converted analog data to a panel in response to the bias voltage received from the bias control circuit. The bias voltage provided by the bias control circuit may correspond to the group of scanning lines and a slew rate of the output buffer unit corresponds to the respective group of scanning lines.

According to an example embodiment, the bias control circuit may provide the bias voltage by counting a number of pulses of a horizontal synchronization signal that synchronizes the scanning lines in each group and by counting the number of the groups of scanning lines.

According to an example embodiment, a liquid crystal display device may include a liquid crystal display panel including a plurality of gate lines and a plurality of data lines, wherein the plurality of data lines are extended from a top end to a bottom end of the liquid crystal display panel; a gate driver for driving the plurality of gate lines, wherein the plurality of gate lines correspond to the plurality of scanning lines; and the source driver according to example embodiments disclosed above for driving the plurality of data lines.

According to an example embodiment, a level of a bias voltage provided by the bias control circuit of the source driver increases in proportion to a distance of the first scanning line of a respective group from the top end of the liquid crystal display panel. Example embodiments provide a bias control circuit capable of gradually controlling a slew rate of an output buffer.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram illustrating a LCD device according to an example embodiment.

FIG. 2 is a block diagram illustrating the source driver in FIG. 1 according to an example embodiment.

FIG. 3 is a block diagram illustrating the bias control circuit in FIG. 2 according to example embodiment.

FIG. 4 is a block diagram illustrating the counter unit in FIG. 3 according to an example embodiment.

FIG. 5 is a block diagram illustrating a counter unit according to another example embodiment.

FIG. 6 is a block diagram illustrating the bias block in FIG. 3.

FIG. 7 is a circuit diagram illustrating the reset circuit in FIG. 3.

FIG. 8A is a timing diagram illustrating various signals of the counter unit, and FIG. 8B is an enlarged timing diagram illustrating a reference numeral 410.

FIG. 9 illustrates the panel and the scanning lines (gate lines).

FIG. 10 illustrates the bias control circuit and the output buffer unit.

FIG. 11 is a simulation diagram illustrating a rise time of the scanning lines from the top end of the panel.

FIGS. 12A and 12B are simulation diagrams illustrating slew rates of groups of scanning lines.

FIG. 13 is a simulation diagram illustrating a peak current.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

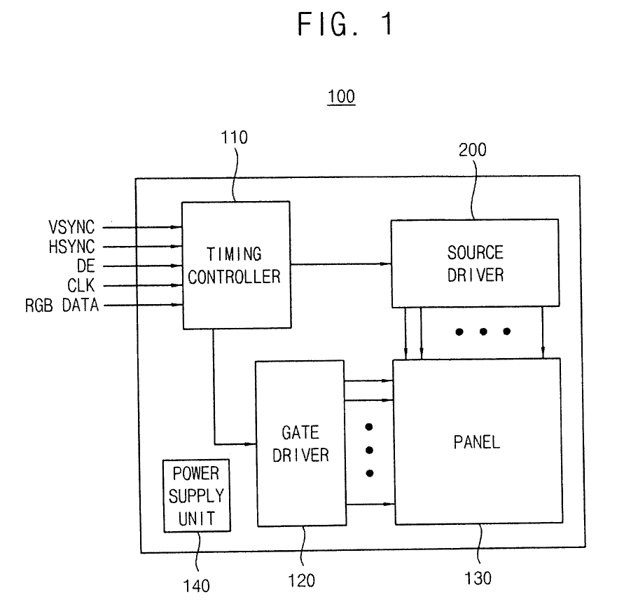

FIG. 1 is a block diagram of a LCD device according to an example embodiment.

Referring to FIG. 1, a LCD device 100 includes a timing controller 110, a source driver 200, a gate driver 120, a LCD panel 130 and a power supply unit 140.

The timing controller 110 receives a vertical synchronization signal VSYNC, a horizontal synchronization signal HSYNC, a data enable signal DE, a clock signal CLK and red, green and blue (RGB) data for each frame from a graphic controller (not illustrated), and transmits the RGB data, a source driver control signal, and a gate driver control signal to the source driver 200 and the gate driver 120.

The source driver 200 receives the RGB data and the source driver control signal from the timing controller 110, and outputs the RGB data to the LCD panel (or panel) 130 in response to the horizontal synchronization signal HSYNC.

The gate driver 120 includes a plurality of gate lines and receives the gate driver control signal output from the timing controller 110. The gate driver 120 controls the gate lines so as to sequentially output, to the panel 130, the data output from the source driver 200.

The power supply unit 140 provides power to the timing controller 110, the source driver 200, the gate driver 120 and the panel 130.

Hereinafter, the operation of the LCD device in FIG. 1 will be described.

The timing controller 110 receives, from the graphic controller (not shown), the RGB data representing an image, the vertical synchronization signal VSYNC and the horizontal synchronization signal HSYNC.

The gate driver 120 receives the gate line control signal, for example, the vertical synchronization signal VSYNC and performs a shift operation on the vertical synchronization signal VSYNC to control the gate lines based on the shifted vertical synchronization signal VSYNC.

The source driver 200 receives the RGB data and the source driver control signal from the timing controller 110, and outputs a single line of the image when the gate driver 120 controls the gate lines based on the shifted vertical synchronization signal VSYNC.

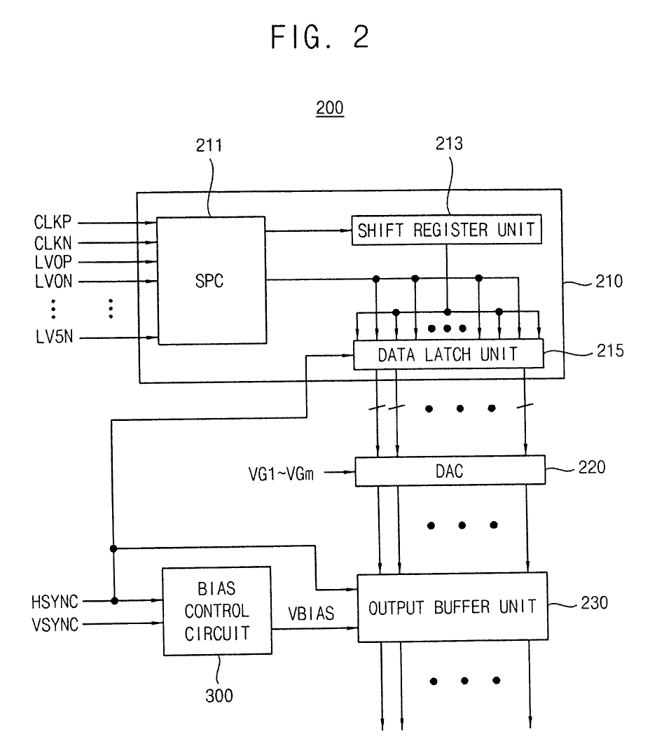

FIG. 2 is a block diagram illustrating the source driver in FIG. 1 according to an example embodiment.

Referring to FIG. 1, the source driver 200 includes an input unit 210, a digital-analog converter (DAC) 220, an output buffer unit 230 and a bias control circuit 300. The input unit 210 includes a serial-parallel converter (SPC) 211, a shift register unit 213, and a data latch unit 215.

The SPC 211 receives, from the timing controller 110 of FIG. 1, clock signals CLKP and CLKN, and the RGB data LV0P, LV0N, . . . , LV5N in serialized Low Voltage Differential Signaling (LVDS) type, serial-parallel converts the RGB data LV0P, LV0N, . . . , LV5N, and provides converted RGB data LV0P, LV0N, . . . , LV5N to the data latch unit 215. In addition, the SPC 211 provides the clock signals CLKP and CLKN to the shift register unit 213. The clock signals CLKP and CLKN may be used for synchronizing output of the shift register unit 213.

The shift register unit 210 receives the clock signals from the SPC 211, and performs a shift operation on the received clock signals. The shift register unit 211 sequentially outputs the shifted clock signal to the data latch unit 215.

The data latch unit 215 includes a plurality of latch circuits, and receives the shifted clock signal output from the shift register unit 213 and the RGB data output from the data register unit SPC 211. The data latch unit 215 sequentially stores, from one end of the latch circuits through to the other end of the latch circuits, the RGB data based on the shifted clock signal.

The DAC 220 receives, from the data latch unit 215, digital data corresponding to a single line of the image and converts the digital data into analog data by using gamma reference voltages VG1˜VGm.

The output buffer unit 230 outputs the analog data, converted by the DAC 220, to the panel 130 in response to a bias voltage VBIAS provided by a group to which the gate lines (scanning lines) belong.

The bias control circuit 300 receives the vertical synchronization signal VSYNC and the horizontal synchronization signal HSYNC, and provides a bias voltage based on a number of scanning lines (that is, the gate lines) that constitute one frame and a number of groups. The scanning lines in one frame are equally divided into the groups.

Hereinafter, operations of the shift register unit 213 and the data latch unit 215 included in the source driver 200 will be described.

The shift register unit 213 receives the clock signal from the SPC 211. The shift register unit 210 performs a shift operation on the received clock signal and outputs, to the data latch unit 215, a latch control signal based on the shifted clock signal.

The data latch unit 215 sequentially stores, from one end of the latch circuits through to the other end of the latch circuits included in the data latch unit 215, the RGB data based on the shifted clock signal.

For example, the shift register unit 213 includes a plurality of shift registers and the shift registers may correspond one-to-one to the latch circuits so as to store the RGB data into one end of the latch circuits through to the other end of the latch circuits.

Hereinafter, it will be described that the panel 130 in FIG. 1 includes 1024 gate (or scanning) lines.

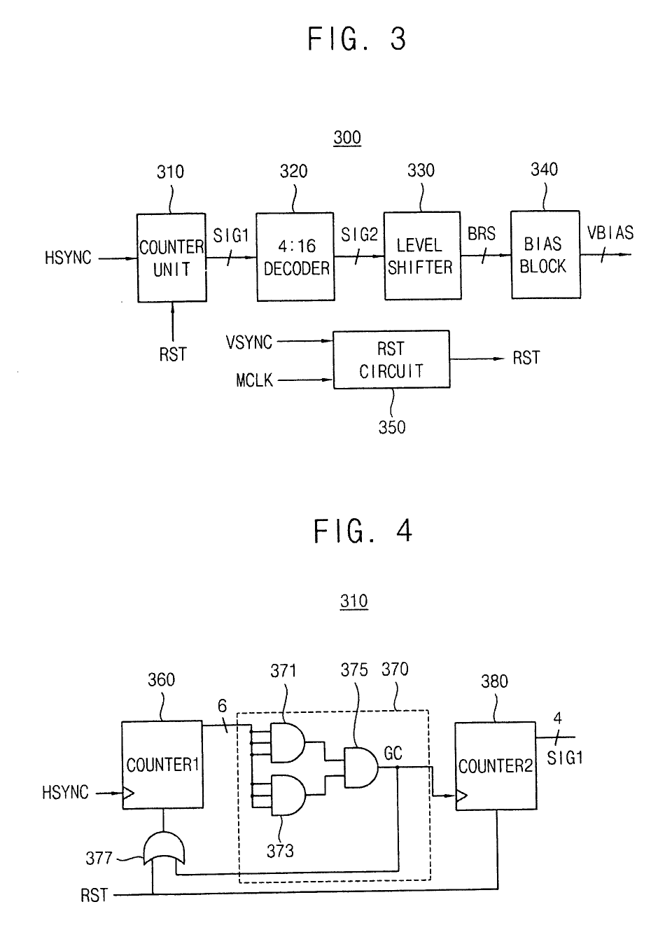

FIG. 3 is a block diagram illustrating the bias control circuit in FIG. 2 according to example embodiment.

Referring to FIG. 3, the bias control circuit 300 includes a counter unit 310, a decoder 320, a level shifter 330, a bias block 340 and a reset circuit 350.

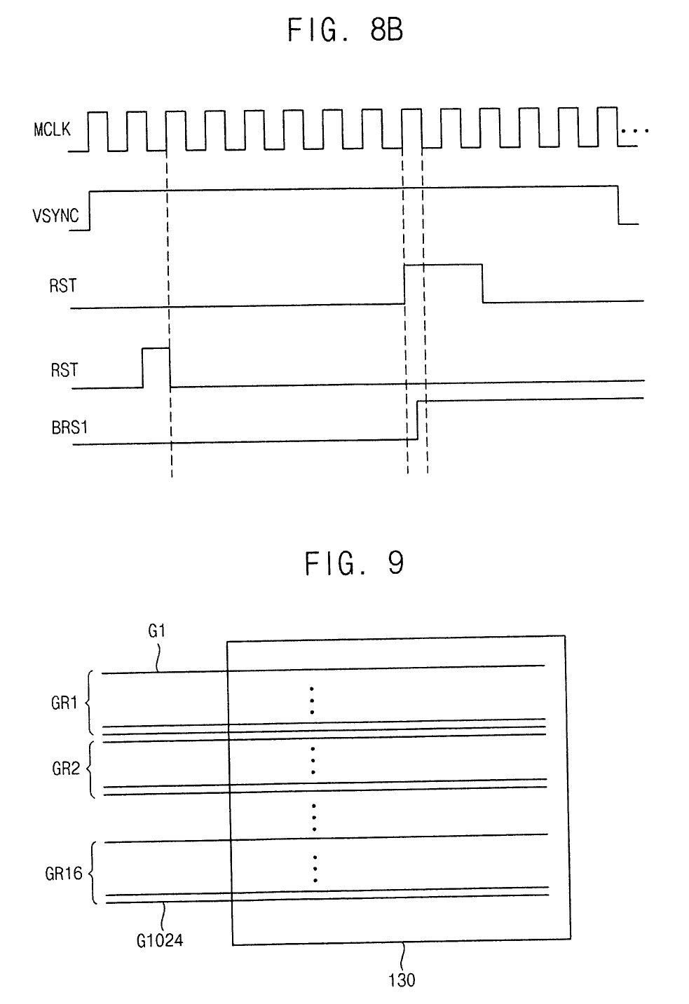

The counter unit 310 provides a first signal SIG1 based on a number of the scanning lines in one frame, and a number of the groups. The scanning lines in one frame may be divided equally into the number of groups. The first signal SIG1 may include a plurality of bits, and may indicate information about the groups. When the panel 130 in FIG. 1 includes 1024 gate lines (scanning lines), the gate lines may be equally divided into 16 groups (Refer to FIG. 9), and each of the 16 groups may therefore include 64 scanning lines (gate lines). Therefore, the counter unit 310 may provide the first signal to indicate a group from the 16 groups.

The decoder 320 decodes the first signal SIG1, and provides a second signal SIG2. The second signal SIG2 may include a plurality of bits.

The level shifter 330 raises voltage level of the second signal SIG2, and provides a bias resistor selection signal BRS. The bias resistor selection signal BRS includes the same plurality of bits as the second signal SIG2, and the bias resistor selection signal BRS is enabled according to each bit value of the second signal SIG2. Each bit of the bias resistor selection signal BRS is applied to a corresponding switch of the bias block 340 (Refer to FIG. 6), the corresponding switch is closed or opened in response to each bit value of the bias resistor selection signal BRS.

The bias block 340 receives the bias resistor selection signal BRS from the level shifter 330, and provides a bias voltage based on a resistance selected in response to a value of the bias resistor selection signal BRS.

The reset circuit 350 generates a reset signal RST for resetting the counter unit 310 based on the horizontal synchronization signal HSYNC and the main clock signal MCLK.

The bias control circuit 300 of FIG. 3 will be described in detail with reference to FIGS. 4 through 9.

FIG. 4 is a block diagram illustrating the counter unit of FIG. 3 according to an example embodiment.

Referring to FIG. 4, the counter unit 310 includes a first counter 360, a logic circuit 370, and a second counter 380. The logic circuit 370 includes AND gates 371, 373, and 375. The counter unit 310 may further include a logic gate 377.

The first counter 360 counts pulses of the horizontal synchronization signal HSYNC. Each pulse of the horizontal synchronization signal HSYNC corresponds to each of the 1024 scanning lines. The first counter 360 counts pulses of the horizontal synchronization signal HSYNC, and outputs the counted result as a 6-bit signal to the logic circuit 370. The logic circuit 370 outputs a group counting signal GC which transitions to a logic high level when the each bit of the 6-bit output of the first counter 360 is a logic high level. The second counter 380 counts the group counting signal GC, and outputs the first signal SIG1. Therefore, the first signal SIG1 includes information about the respective 64 groups. The logic gate 377 receives the group counting signal GC and the reset signal RST, performs a logic operation on the group counting signal GC and the reset signal RST, and resets the first counter 360. For example, the first counter 360 is reset when the group counting signal GC or the reset signal RST is a logic high level.

In other words, when one frame includes 1024 scanning lines and the 1024 scanning lines are equally divided into the 16 groups (Refer to FIG. 9), the first counter 360 counts pulses of the horizontal synchronization signal HSYNC, and outputs a 6-bit signal representing the counted result. The logic circuit 370 outputs the group counting signal GC which, for example, is logic “one” when each bit of the 6-bit output of the first counter 360, for example, is logic “one”, i.e., when the first counter 360 counts a 64^{th} scanning line. The second counter 380 counts the group counting signal GC, and outputs the 4-bit first signal SIG1. The 4-bit first signal SIG1 includes the information about the group that includes scanning lines that the first counter 360 is counting.

For example, when the first signal SIG1 is “0010”, “0010” indicates that the first counter 360 counting a fourth group GR4. Table 1 below illustrates a relationship between each bit of the first signal SIG1 and respective groups of FIG. 9

TABLE 1

| SIG1 | GROUP |
|---|---|
| 0000 | GR1 |
| 0001 | GR2 |
| 0010 | GR3 |
| 0011 | GR4 |
| 0100 | GR5 |
| 0101 | GR6 |
| 0110 | GR7 |
| 0111 | GR8 |
| 1000 | GR9 |
| 1001 | GR10 |
| 1010 | GR11 |
| 1011 | GR12 |
| 1100 | GR13 |
| 1101 | GR14 |
| 1110 | GR15 |
| 1111 | GR16 |

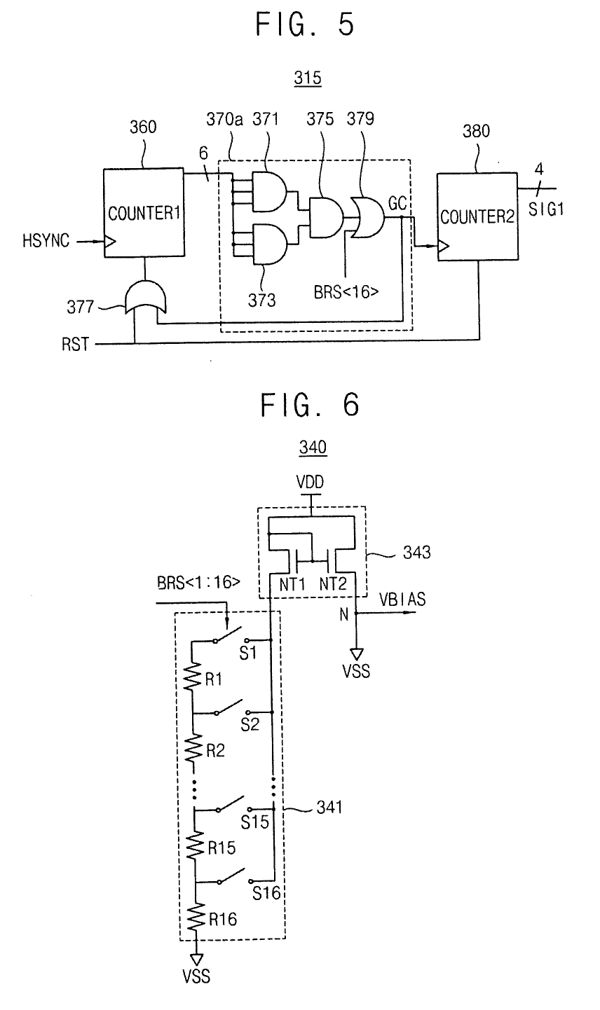

FIG. 5 is a block diagram illustrating a counter unit according to another example embodiment.

The counter unit 315 of FIG. 5 may be employed in the bias control circuit 300 instead of the counter unit 310 of FIG. 4. The counter unit 315 of FIG. 5 is different from the counter unit 310 of FIG. 4 in that a logic circuit 370a includes the AND gates 371, 373, and 375, and an OR gate 379. The OR gate 379 receives an output of the AND gate 375 and the bias resistor selection signal BRS<16>, and the output of OR gate 379 operates the second counter 380 and resets the first counter 360.

Referring again to FIG. 3, the decoder 320 decodes the 4-bit first signal SIG1, and outputs the 16-bit second signal SIG2. The level shifter 330 shifts a voltage level of the 16-bit second signal SIG2 to provide the bias resistor selection signal BRS to the bias block 340. The bias resistor selection signal BRS is also a 16-bit signal. One of the bias resistors in the bias block 340 is selected according to a bit level (high-level, for example) of the 16-bit bias resistor selection signal BRS and a bias voltage is provided according to the selected bias resistor.

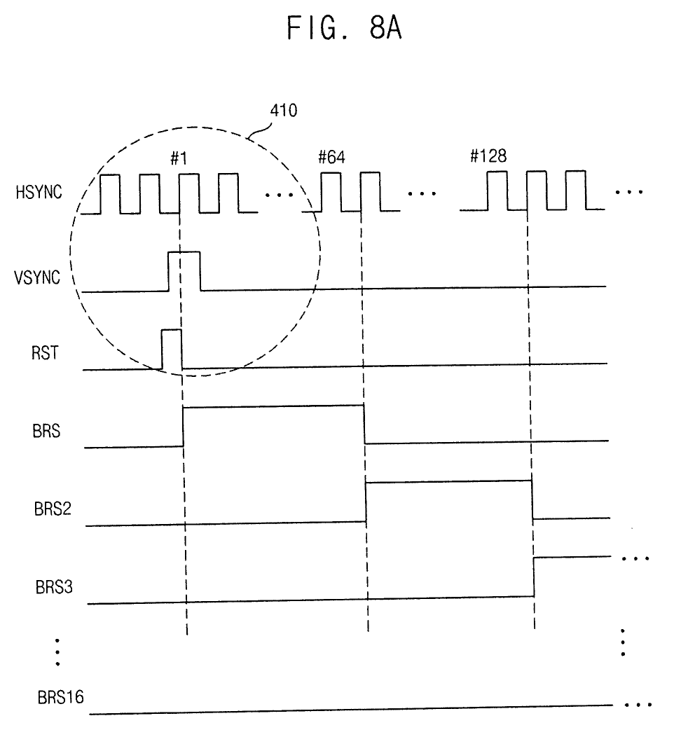

Each bit of the bias resistor selection signal BRS is enabled in [Table 1], during when the first counter 360 counts the scanning lines of the corresponding group. Referring to FIG. 6, corresponding switch is closed when each bit of the bias resistor selection signal BRS is enabled, which will be described later with reference to FIGS. 8A and 8B.

FIG. 6 is a block diagram illustrating the bias block in FIG. 3.

Referring to FIG. 6, the bias block 340 includes a resistor unit 341 and a current mirror 343 connected to a power supply voltage VDD. The resistor unit 341 includes resistors R1˜R16, connected in series with respect to each other, and switches S1˜S16. Each of the switches S1˜S16 is connected to each of the resistors R1˜R16. The current mirror 343 includes n-type metal oxide semiconductor (MOS) transistors NT1 and NT2. The resistors R1˜R16 may have a same resistance, i.e., R.

One of the switches S1˜S16 is closed according to each bit value of 16-bit bias resistor selection signal BRS, the corresponding bias voltage VBIAS is provided at a node N according to the closed switch. For example, when a most significant bit (MSB) of the bias resistor selection signal BRS is “1”, this corresponds to the first group GP1, which is placed uppermost in the panel 130. Therefore, the switch S1 is closed, and bias voltage VBIAS of VDD/16R is provided at the node N1. For example, when a least significant bit (LSB) of the bias resistor selection signal BRS is “1”, this corresponds to the first group GP16, which is placed lowermost in the panel 130. Therefore, the switch S16 is closed, and bias voltage VBIAS of VDD/R is provided at the node N1. When the bias resistor selection signal BRS is a 16-bit signal, each of switches S1˜S16 is closed or opened according to the status of each bit of bias resistor selection signal BRS. Each bit of 16-bit bias resistor selection signal BRS may be represented as BRS1˜BRS16. Each of the first through 16^{th} bias resistor selection signals BRS1˜BRS16 is applied to each of the switches S1˜S16, and one of the switches S1˜S16, which receives a high-level bit of the bias resistor selection signal, is closed.

Each of the first through 16^{th} bias resistor selection signals BRS1˜BRS16 is applied to each of the switches S1˜S16, and each of the first through 16^{th} bias resistor selection signals BRS1˜BRS16 is in high level thereby closing the corresponding switch during when the first counter 360 counts the scanning lines of the corresponding group (Refer to FIG. 9). Table 2 below illustrates relationship between the first signal SIG1, the bias resistor selection signal BRS, the switch that is connected, and the bias voltage VBIAS. In the case illustrated in Table 2, resistance of each resistor R1˜R16 corresponds to R, and voltage drops of the NMOS transistors NT1 and NT2 are ignored.

TABLE 2

| | BRS | Switch | VBIAS |
|---|---|---|---|
| 0000 | 1000000000000000 | S1 | VDD/16R |
| 0001 | 0100000000000000 | S2 | VDD/15R |
| 0010 | 0010000000000000 | S3 | VDD/14R |
| 0011 | 0001000000000000 | S4 | VDD/13R |
| 0100 | 0000100000000000 | S5 | VDD/12R |
| 0101 | 0000010000000000 | S6 | VDD/11R |
| 0110 | 0000001000000000 | S7 | VDD/10R |
| 0111 | 0000000100000000 | S8 | VDD/9R |
| 1000 | 0000000010000000 | S9 | VDD/8R |
| 1001 | 0000000001000000 | S10 | VDD/7R |
| 1010 | 0000000000100000 | S11 | VDD/6R |
| 1011 | 0000000000010000 | S12 | VDD/5R |
| 1100 | 0000000000001000 | S13 | VDD/4R |
| 1101 | 0000000000000100 | S14 | VDD/3R |
| 1110 | 0000000000000010 | S15 | VDD/2R |
| 1111 | 0000000000000001 | S16 | VDD/1R |

Each bit value of the bias resistor selection signals BRS is identical to each bit value of the second signal SIG2 which is the output of the decoder 320. That is, the decoder 320 decodes the first signal SIG1 to the bias resistor selection signals BRS of Table 2 according to the each bit value of the 4-bit first signal SIG1.

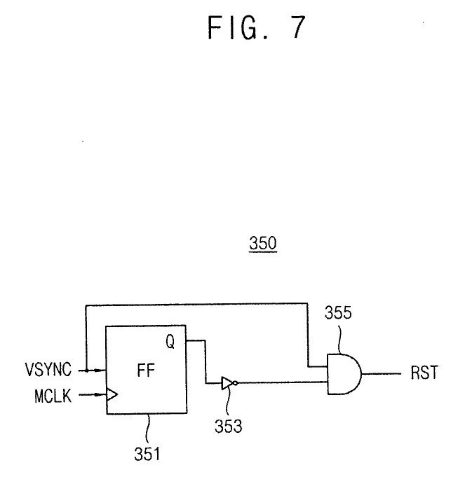

FIG. 7 is a circuit diagram illustrating the reset circuit in FIG. 3.

Referring to FIG. 7, the reset circuit 350 includes a flip-flop 351, an inverter 353 and an AND gate 355. The flip-flop 351 outputs the vertical synchronization signal VSYNC at an output terminal Q in synchronization with the main clock signal MCLK. The inverter 353 inverts the output of the flip-flop 351, and the AND gate 355 performs an AND operation on the vertical synchronization signal VSYNC and the output of the inverter 353 to provide the reset signal RST. The reset signal RST is provided to the counter unit 310, and the first counter 360 and the second counter 380 are reset by the reset signal RST when the counting operation for one frame is completed.

FIG. 8A is a timing diagram illustrating various signals of the counter unit, and FIG. 8B is an enlarged timing diagram illustrating a reference numeral 410.

In FIG. 8A, the main clock signal MCLK is not illustrated for the sake of convenience.

FIG. 9 illustrates the panel and the scanning lines (gate lines).

In FIG. 9, the 1024 scanning lines G1˜G1024 are included in the panel 130, and the 1024 scanning lines (G1˜G1024) are equally divided into the 16 groups GR1˜GR16, each of the 16 groups GR1˜GR16 including 64 scanning lines.

FIG. 10 illustrates the bias control circuit 300 and the output buffer unit 230 of FIG. 2. In FIG. 10, the output buffer unit 230 includes a plurality of output buffers 231.

Referring to FIGS. 3 to 9, the operation of the bias control circuit 300 will be described.

Referring now to FIGS. 8A and 8B, the horizontal synchronization signal HSYNC synchronizes the scanning lines constituting one frame. Here, #1 represents a first scanning line (or gate line) of the panel 130, #64 represents a 64^{th} scanning line from the top end of the panel 130, and #128 represents a 128^{th} scanning line from the top end of the panel 130. One frame starts with the vertical synchronization signal VSYNC, and the reset signal RST is simultaneously enabled, thereby resetting the first counter 360 and the second counter 380.

The bias resistor selection signal BRS is maintained with “1000000000000000” as illustrated in [Table 2] (that is, the first bias resistor selection signal BRS1 is enabled), the first switch S1 is closed, and the bias voltage VBIAS of VDD/16R is provided to the output buffer unit 230, while the first counter 360 counts the first through 64^{th} scanning lines in the first group GR1. At this time, the first signal SIG1, the output of the second counter 380 is “0000”. When the first counter 360 completes counting the 64^{th} scanning line of the first group GR1, the group counting signal GC transitions to high level, and the first counter 360 is reset by the group counting signal GC.

The bias resistor selection signal BRS is maintained at “0100000000000000” as illustrated in [Table 2] (that is, the second bias resistor selection signal BRS2 is enabled), the second switch S2 is closed, and the bias voltage VBIAS of VDD/15R is provided to the output buffer unit 230, while the first counter 360 counts the 65^{th} through 128^{th} scanning lines in the second group GR2. At this time, the first signal SIG1, the output of the second counter 380 is “0001”. When the first counter 360 completes counting the 128^{th} scanning line of the first group GR2, the group counting signal GC transitions to high level, and the first counter 360 is reset by the group counting signal GC.

The bias control circuit 300 provides a gradually increasing bias voltage to the output buffer 231 of the output buffer unit 230 by counting the number of scanning lines of each group, i.e., the number of the pulses of the horizontal synchronization signal HSYNC. The bias control circuit 300 provides, to the output buffer 231 that drives the scanning lines, the gradually increasing bias voltage from the top end to the bottom end of the panel 130. This is done considering the varying slew rates of each group of scanning lines from the top to the bottom of the panel 130, and thereby avoids providing a same bias voltage to all the groups. Therefore, a current consumption may be reduced.

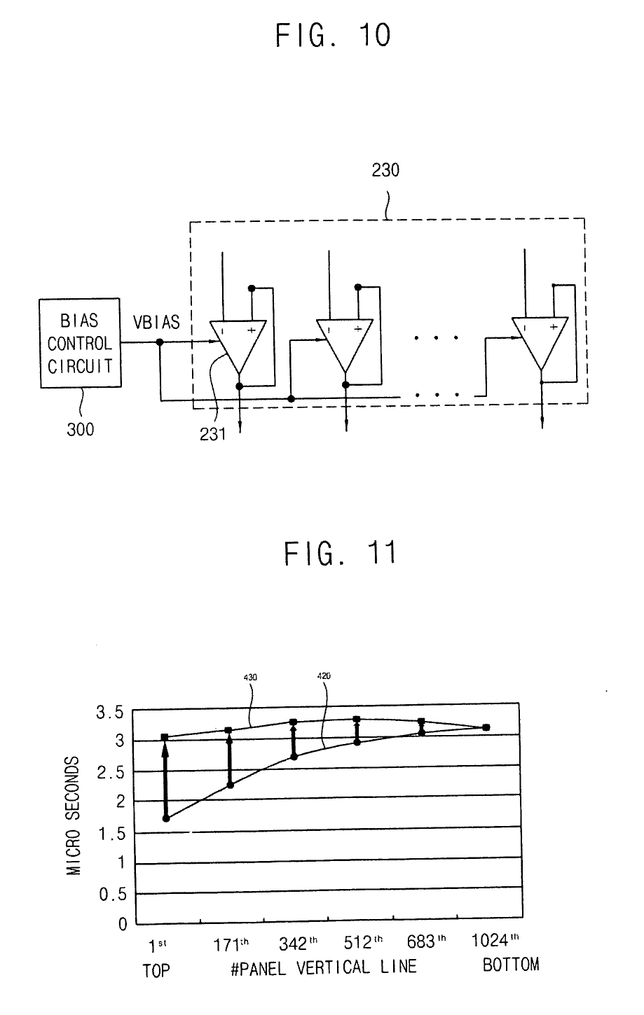

FIG. 11 is a simulation diagram illustrating a rise time of the scanning lines from the top end of the panel.

In FIG. 11, a reference numeral 420 illustrates a simulation diagram when the same bias voltage (for example, equal to the bias voltage applied to the group GR16 in FIG. 9) is applied to all groups in FIG. 9, and a reference numeral 430 illustrates a simulation diagram when the gradually increasing bias voltages are applied to each group in FIG. 9 according to the example embodiment described above. Referring to FIG. 11, it is noted that the rise time of each group has little difference when compared with the reference numeral 420.

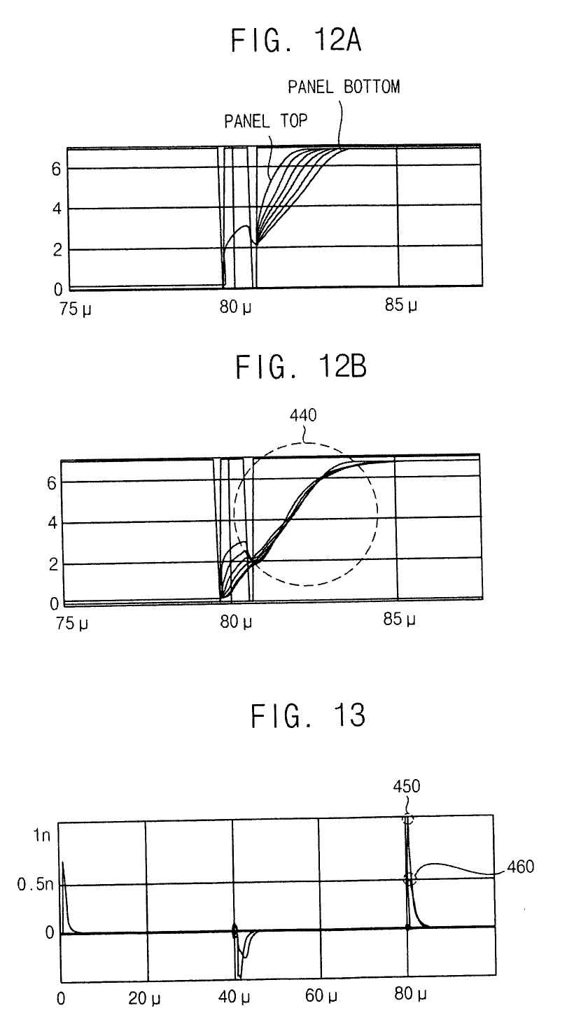

FIGS. 12A and 12B are simulation diagrams illustrating slew rates of groups.

FIG. 12A illustrates a simulation diagram when the same bias voltage, the bias voltage applied to the group GR16 in FIG. 9, is applied to all groups in FIG. 9, and FIG. 12B illustrates a simulation diagram when the gradually increasing bias voltages are applied to each group in FIG. 9 according to an example embodiment.

Referring to FIGS. 12A and 12B, it is noted that there is a considerable difference in the slew rates of the groups (for example, the group G1 in the top end of the panel 130 and the group G16 in the bottom end of the panel 130) in FIG. 12A. However, it is noted that there is little difference of the slew rates of the groups, as is illustrated in reference numeral 440.

FIG. 13 is a simulation diagram illustrating a peak current when the bias voltages are applied to the output buffer unit of FIG. 10 according to an example embodiment.

In FIG. 13, a reference numeral 450 illustrates a simulation diagram when the bias voltage applied to the group GR16 of FIG. 9 is applied to all groups of FIG. 9, and a reference numeral 460 illustrates a simulation diagram when the gradually increasing bias voltages are applied to each group of FIG. 9, according to an example embodiment. Referring to FIG. 13, it is noted that the peak current is reduced by about half when a gradually increasing voltage is applied.

Table 3 illustrates current consumption according to input data patterns when the bias voltages are applied to the output buffer unit of FIG. 10 according to an example embodiment. Table 3 illustrates current consumption when the group GR1 in the top end of the panel 130 is considered.

TABLE 3

| | | Current consumption |
|---|---|---|
| | Current consumption | device according to |
| Input data | in conventional devices | example embodiments |
| Black Pattern | 9.867 mA | 8.105 mA |
| White Pattern | 5.761 mA | 3.144 mA |
| One Dot Pattern | 11.39 mA | 9.304 mA |

Referring to Table 3, when the input data is a black pattern, the current consumption is reduced by about 17.8%. When the input data is a white pattern, the current consumption is reduced by about 45.4%. When the input data is a one dot pattern, the current consumption is reduced by about 18.3%.

When the scanning lines constituting one frame are equally divided into a plurality of groups, and the bias voltages, applied to the output buffer unit, increase gradually from the top end of the panel to the bottom end of the panel, there is little difference of the slew rates in the vertical direction of the panel, a current consumption is reduced, and the Electromagnetic Interference (EMI) is reduced due to a reduction in the peak current.

As a result, example embodiments may be applied to large-sized televisions, thereby reducing the current consumption and heat radiation.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A bias control circuit comprising:
a counter unit configured to provide plurality bits of a first signal indicating information on a plurality of scanning lines divided into a equal number of a plurality of groups, the plurality of scanning lines constituting one frame;
a decoder configured to decode the first signal to provide a plurality of bits of a second signal;
a level shifter configured to shift a voltage level of the second signal to provide a bias resistor selection signal, the bias resistor selection signal being enabled based on bit value of the second signal; and
a bias block configured to select a resistance based on a value of the bias resistor selection signal and configured to provide a bias voltage corresponding to the resistance selected.

2. The bias control circuit of claim 1, wherein the counter unit comprises:
a first counter that counts a pulse of a horizontal synchronization signal that synchronizes the scanning lines in each group;
a logic circuit that provides a group counting signal which is enabled when the first counter completes counting the scanning lines in each group; and
a second counter that counts the group counting signal to provide the first signal.

3. The bias control circuit of claim 2, wherein the first counter is reset when the first counter completes counting the scanning lines in each group, and the first counter and the second counter are reset in response to a vertical synchronization signal that synchronizes the one frame.

4. The bias control circuit of claim 2, wherein the logic circuit comprises:
a first AND gate that receives upper half bits of an output of the first counter;
a second AND gate that receives lower half bits of the output of the first counter; and
a third AND gate that performs a logic operation on the outputs of the first and second AND gates to provide the group counting signal.

5. The bias control circuit of claim 2, wherein the logic circuit comprises:
a first AND gate that receives upper half bits of an output of the first counter;
a second AND gate that receives lower half bits of the output of the first counter;
a third AND gate that performs a logic operation on the outputs of the first and second AND gates; and
an OR gate that performs a logic operation on the outputs of the third AND gate and the bias resistor selection signal to provide the group counting signal.

6. The bias control circuit of claim 1, wherein the bias resistor selection signal is enabled during the counting of the plurality of scanning lines.

7. The bias control circuit of claim 1, wherein the bias block comprises:
a plurality of switches that receive the bias resistor selection signal; and
a plurality of resistors, each resistor of the plurality of resistors being connected to each switch of the plurality of switches, wherein each resistor is connected in response to the bias resistor selection signal to provide a corresponding bias voltage.

8. The bias control circuit of claim 2, further comprising:
a reset circuit that generates a reset signal which simultaneously resets the first counter and the second counter in response to a main clock signal and a vertical synchronization signal.

9. A source driver comprising:
the bias control circuit of claim 1;
an input unit which receives digital data signal and sequentially stores the digital data signal;
a digital to analog converter configured to convert the stored digital data signal to an analog data; and
an output buffer unit configured to output the converted analog data to a panel in response to the bias voltage received from the bias control circuit,
wherein the bias voltage provided by the bias control circuit corresponds to the group of scanning lines and a slew rate of the output buffer unit corresponds to the respective group of scanning lines.

10. The source driver of claim 9, wherein the bias control circuit provides the bias voltage by counting a number of pulses of a horizontal synchronization signal that synchronizes the scanning lines in each group and by counting the number of the groups of scanning lines.

11. A liquid crystal display device, comprising:
a liquid crystal display panel including a plurality of gate lines and a plurality of data lines, wherein the plurality of data lines are extended from a top end to a bottom end of the liquid crystal display panel;
a gate driver for driving the plurality of gate lines, wherein the plurality of gate lines correspond to the plurality of scanning lines; and
the source driver of claim 9 for driving the plurality of data lines.

12. The liquid crystal display device of claim 11, wherein a level of a bias voltage provided by the bias control circuit of the source driver increases in proportion to a distance of the first scanning line of a respective group from the top end of the liquid crystal display panel.
